(19) United States
(12) Patent Application Publication
(10) Pub. No.: US 2015/0282526 A1
(43) Pub. Date: Oct. 8, 2015

(54) TOBACCO VAPORIZER

(71) Applicant: Changming WU, (US)

(72) Inventor: Changming Wu, Suzhou City (CN)

(21) Appl. No.: 13/883,955

(22) PCT Filed: Dec. 28, 2012
(86) PCT No.: PCT/CN2012/087819

§ 371 Date: May 7, 2013

(51) Int. Cl. A24F 47/00; H05B 1/02

(52) U.S. Cl. CPC A24F 47/008; H05B 1/0244

(57) ABSTRACT

This invention relates to a tobacco vaporizer. The tobacco vaporizer includes a heating assembly, an electrode assembly, a battery assembly and a control assembly; the heating assembly further comprises a heating chamber configured to contain the substance to be vaporized and a heating wire in the heating chamber; the heating wire is connected to the battery assembly through the electrode assembly to obtain electric energy. When implementing the tobacco vaporizer of this invention, the tobacco vaporizer can enlarge contacting area between the heating wire and the substance to be vaporized by placing the heating wire in the heating chamber. It can extract sufficiently the useful component of the substance that is to be vaporized to make the smokers enjoy the special taste and smell of the tobacco, and there are no produced harmful substance, such as CO, tobacco tar and dust and so on.

### FIELD OF THE INVENTION

This present invention relates to the technical field of electro-heating technology, and more particularly relates to a tobacco vaporizer configured to vaporize tobacco by heating wire.

### BACKGROUND OF THE INVENTION

At present, smoking device, such as direct-fired smoking device, liquid tobacco tar electronic cigarette and so on, extracting useful component of vaporized substance mainly by two means that one is directly combustion and another is high temperature baking The drawback of the directly combustion is that the tobacco would split if there were a flame formed by the combustion. When the tobacco splits, the tobacco would release a big amount of harmful substance, such as CO, tobacco tar and dust and so on. Wherein, such harmful substance may cause cancer and influence others' healthy. The way of the high temperature baking adapted by the electronic cigarette, in some extant, reduces the production of the harmful substance, such as CO, tobacco tar and so on. However, by compared with the way of direct combustion, the tobacco baked at high temperature is heated insufficiently, which will result in that the useful component volatilizes insufficiently, and reduce the special smell and taste of the tobacco, then influence the effect of smoking.

### SUMMARY OF THE INVENTION

Aiming at the drawbacks in the prior art that the smoking device prone to produce harmful substance for human or leads to bad taste for smoking, a tobacco vaporizer that can avoid to generate harmful split production and assure a good taste for smoking is provided.

According to an aspect, a proposed tobacco vaporizer includes a heating assembly, an electrode assembly, a battery assembly and a control assembly; and

wherein the heating assembly comprises a heating chamber configured to contain the substance to be vaporized and a heating wire in the heating chamber; and

the heating wire is connected to the battery assembly through the electrode assembly to obtain electric energy, then the heating wire generates heat by the electric energy from the battery assembly to vaporize the contained substance to be vaporized; and

the control assembly controls a connection between the battery assembly and the heating wire being open or closed and regulates an output voltage of the battery assembly.

Preferably, the electrode assembly comprises an inner electrode and an outer electrode, an insulated part that is insulated silicone gel located between the inner electrode and the outer electrode.

Preferably, the control assembly comprises a control circuit and a control button.

Preferably, the control assembly comprises a temperature sensing circuit configured to sense the temperature of the heating chamber.

When implementing the tobacco vaporizer of this invention, the following advantageous effects achieve:

the tobacco vaporizer can enlarge contacting area between the heating wire and the substance to be vaporized by placing the heating wire in the heating chamber. Under the premises of flameless, the tobacco is heated sufficiently by the tobacco vaporizer, which can extract sufficiently the useful component of the substance that is to be vaporized to make the smokers enjoy the special taste and smell of the tobacco, and there are no produced the harmful substance, such as CO, tobacco tar and dust and so on.

### BRIEF DESCRIPTION OF THE DRAWINGS

The present invention can be further illustrated by reading the examples with references made to the accompanying drawings, in which:

FIG. 1 is a schematic structure diagram of a tobacco vaporizer in the embodiment of the present invention.

### DETAILED DESCRIPTION OF THE PREFERRED EMBODIMENT

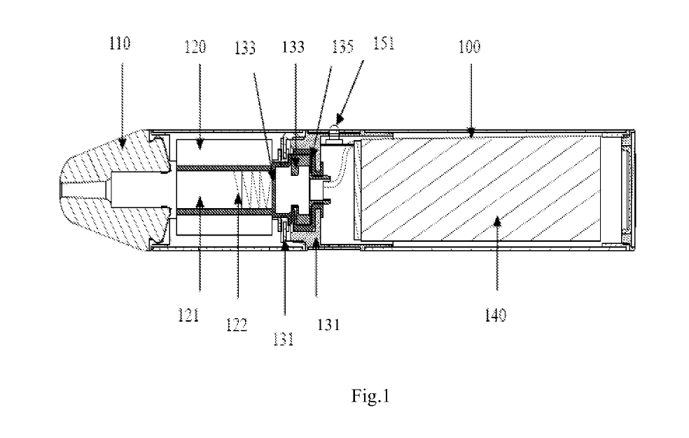

FIG. 1 is a schematic structure diagram of a tobacco vaporizer in the embodiment of the present invention.

Referring to FIG. 1, the tobacco vaporizer of the present invention includes a shell 100, a suction mouth 110, a heating assembly 120, an electrode assembly, a battery assembly 140 and a control assembly. In this embodiment, the heating assembly 120, the electrode assembly, the battery assembly 140 and the control assembly are placed in the shell 100. The shell 100 is of a substantially tubular structure, but it is not limited in the structure of the embodiment.

The heating assembly 120 includes a heating chamber 121 and a heating wire 122. Wherein the heating chamber 121 is configured to contain substance that is to be vaporized, such as cigarette, tobacco cut, herbs or volatility medicine and so on. The heating wire 122 placed in the heating chamber 121 can generate heat by power on, which can provide thermal energy for the heating chamber 121 to vaporize the cigarette, tobacco cut, herbs or volatility medicine. A sealed connection is between the suction mouth 110 and the shell 100. An air exhaust hole is set in the inner of the suction mouth 110. The air exhaust hole is through to the heating chamber 121. An extraction obtained by the way of heating to vaporizing in the heating chamber 121 can enter in human body through the air exhaust hole. The heating wire 122 is in electronic connection with the battery assembly 140 through the electrode assembly. The electrode assembly includes an outer electrode 131, an inner electrode 133 as well as an insulated part 135. The insulated part 135 preferably is insulated silicon gel. Wherein the insulated part 135 is located between the inner electrode 133 and the outer electrode 131, and it is used to prevent electric charge on the inner electrode 133 from drifting to the outer electrode 131. An anode of the battery assembly 140, the inner electrode 133, the heating wire 122, the outer electrode 131 and a cathode of the battery assembly 140 are sequentially connected, thus a circuit loop forms. The battery assembly 140 provides work voltage for heating wire through the circuit loop.

In the embodiment, the output voltage of the battery assembly 140 is adjustable. In implementing, the control assembly can regulate the output voltage. The control assembly includes a control circuit and a control button 151. The control button 151 is mounted on the shell 100. By utilizing the control button 151 and the control circuit, users can control the connection between the heating wire 122 and the battery assembly 140 being open or closed. The control circuit further includes a temperature sensing circuit. When the temperature sensing circuit senses a temperature of the heating chamber 121 being higher than a preset value, the control circuit regulates supply power to a low voltage. In such case, it can prevent the temperature of the heating chamber 121 from higher than the preset value, thereby avoiding the cigarette, tobacco cut, herbs or volatility medicine and so on in heating chamber 121 to spilt and produce harmful substance for human.

Further, in this embodiment, if users want to smoke, they can put the tobacco (may be tobacco cut or cigarette and so on) in the heating chamber 121, then triggers the control button 151. When the control circuit of the control assembly detects a trigger signal, the control circuit controls the connection between the battery assembly 140 and the heating wire 122 be closed. The battery assembly 140 starts to provide power for the heating wire 122. Then the heating wire 122 provides thermal energy to the heating chamber 121 to vaporize the cigarette or tobacco cut. Substance generated by vaporizing enters to human body through the air exhaust hole of the suction mouth 110. Because of the heating wire 122 placed in the heating chamber 122 and stretched into the inner of the tobacco, the contacting area between the heating wire 122 and the tobacco can be enlarged. In such case, under the premises of flameless, the tobacco may be fully heated and then the useful component may be fully extracted, which can make users enjoy a special taste and smell of the tobacco. At the same time, when the temperature sensing circuit of the control circuit senses that the temperature of the heating chamber 121 reaches in the preset value(the preset value is lower than 500° C.), the control circuit regulates the output voltage of the battery assembly to a low level. In such case, it can assure that the temperature of the heating chamber 121 is no higher than the preset value. Wherein at such temperature, the harmful substance produced in high temperature can be avoid. When users finished smoking, they can trigger the control button 151 again to make the tobacco vaporizer stop.

While the present invention has been described by reference to preferred embodiments, it will be understood by those skilled in the art that various changes may be made and equivalents may be substituted without departing from the scope of the present invention. However, all the changes will be included within the scope of the appended claims.

1. A tobacco vaporizer comprising a heating assembly, an electrode assembly, a battery assembly and a control assembly; and
wherein the heating assembly comprises a heating chamber configured to contain the substance to be vaporized and a heating wire in the heating chamber;
the heating wire is connected to the battery assembly through the electrode assembly to obtain electric energy, then the heating wire generates heat by the electric energy from the battery assembly to vaporize the contained substance to be vaporized; and
the control assembly controls a connection between the battery assembly and the heating wire being open or closed and regulates an output voltage of the battery assembly.

2. The tobacco vaporizer of claim 1, wherein the electrode assembly comprises an inner electrode and an outer electrode, an insulated part that is insulated silicone gel located between the inner electrode and the outer electrode.

3. The tobacco vaporizer of claim 1, wherein the control assembly comprises a control circuit and a control button.

4. The tobacco vaporizer of claim 3, wherein the control assembly comprises a temperature sensing circuit configured to sense the temperature of the heating chamber.
